(19) United States
(12) Patent Application Publication
(10) Pub. No.: US 2026/0227554 A1
(43) Pub. Date: Aug. 6, 2026

(54) METHOD FOR MANUFACTURING A DIFFRACTIVE OPTICAL ELEMENT

(71) Applicant: RHEINISCHE FRIEDRICH-WILHELMS-UNIVERSITÄT BONN, Bonn (DE)

(72) Inventor: Martin WEITZ, Bonn (DE)

(21) Appl. No.: 19/152,783

(22) PCT Filed: Jan. 30, 2024
(86) PCT No.: PCT/EP2024/052200

§ 371 Date: Jul. 31, 2025

(30) Foreign Application Priority Data
Jan. 31, 2023 (DE) 102023102332.2

(51) Int. Cl. G02B 5/18; G02B 5/08

(52) U.S. Cl. CPC G02B 5/1852; G02B 5/0891; G02B 5/1814; G02B 5/1861

(57) ABSTRACT

A method for manufacturing a diffractive optical element for beam shaping of a light beam with a first wavelength of at least 10 nm is disclosed. The method includes providing a laser mirror, wherein the laser mirror includes a layered structure including a substrate, a dielectric layer, and an electrically conductive reflection layer, wherein the dielectric layer is adjacent to the substrate, or wherein the laser mirror includes a layered structure including a substrate, a dielectric layer, an electrically conductive reflection layer, and an absorption layer, wherein the absorption layer is located between the substrate and the dielectric layer. The method further includes generating a plurality of bulges in the electrically conductive reflection layer by treating the laser mirror with heating laser radiation including a second wavelength.

The invention relates to a method for manufacturing a continuous diffractive optical element for beam shaping of a light beam with a first wavelength.

Diffractive optical elements, abbreviated DOE, allow the beam shaping of a light beam, i.e. the targeted modification of the intensity distribution of the light beam profile perpendicular to the direction of propagation. For beam shaping, the DOE is inserted into the light beam, whereby different optical path lengths at the DOE cause phase modulations of the light beam, resulting in interference patterns. Through constructive and destructive interference, the intensity of the light beam is spatially modulated. In this way, the typically Gaussian intensity profile of the light beam can be specifically modified and converted into a doughnut-shaped intensity profile, for example. In general, DOEs not only deflect the light beam in one direction, but also distribute it, as far as it is not absorbed, to a large number of deflection angles, each representing different diffraction orders. In most cases, this effect is undesirable and as high a proportion as possible should be deflected into exactly one useful diffraction order, where the desired intensity profile is formed. The remaining light beam is distributed largely to other diffraction orders and is considered to be diffraction noise or stray light, which must be minimised. The shape of the surface profile of the DOE, which must correspond as closely as possible to a desired, previously calculated profile, has a significant influence on the suppression of unwanted orders. In order to achieve high diffraction efficiency in the desired diffraction order and, accordingly, good suppression of stray light, high precision in the manufacturing process of the DOE is crucial.

DOEs known in the prior art are glass or plastic substrates onto which microstructures are applied by laser lithography and/or photolithography as well as by various wet and dry chemical etching processes. For example, a blazed grating, an optical grating in which the individual grating lines have a triangular cross-section in a sawtooth shape, can be applied as a microstructure, maximising the diffraction efficiency for a specific diffraction order. Due to the manufacturing process, the desired height profile is usually approximated by a staircase profile with a specific number of steps. In order to achieve a high number of stair steps, which is necessary for the most accurate possible generation of the desired profile of the DOE and thus high diffraction efficiency in the desired useful diffraction order, a multiple number of etching processes are required. This involves considerable effort.

Furthermore, continuous DOEs are known from the prior art which feature structuring of the height profile of dielectric laser mirrors by creating bulges in these multi-layer structures. The dielectric arrangement responsible for the reflection of these mirrors comprises several layers of alternately low-and high-refractive materials, each with an optical thickness of a quarter of the wavelength to be reflected. The bulges in the dielectric layer structure required for this method of generating a DOE are produced by heating laser radiation, which can be absorbed in a metallic silicon layer located beneath the dielectric layers. The bulges produced after irradiation with a focused heating laser beam have a cross-section in the form of a Gaussian distribution, the width of which corresponds to approximately twice the thickness of the reflective dielectric multilayer arrangement. The width of the bulge limits the minimum distance between two adjacent bulges. This parameter determines the achievable resolution of the structuring process in the horizontal direction. The smaller the dimensions of the structures that can be reproduced, the more accurately the desired surface profile of the DOE can be produced for microscopic structures.

Based on this, it is an object of the invention to provide a method and device for manufacturing a DOE that enables high manufacturing precision.

This object is solved by the subject matter of claim 1. Preferred further developments are found in the subclaims.

The invention thus provides a method for manufacturing a diffractive optical element for beam shaping of a light beam with a first wavelength of at least 10 nm, comprising the following method steps
providing a laser mirror, wherein the laser mirror has a layer-like structure comprising a substrate, a dielectric layer and an electrically conductive reflection layer, wherein the dielectric layer is adjacent to the substrate, or wherein the laser mirror has a layered structure comprising a substrate, a dielectric layer, an electrically conductive reflection layer and an absorption layer, wherein the absorption layer is located between the
generating a plurality of bulges in the electrically conductive reflective layer by treating the laser mirror with heating laser radiation having a second wavelength.

A key feature of the invention is that a continuous DOE is produced by generating bulges in an electrically conductive reflective layer of a laser mirror by means of targeted heating. In contrast to the methods known in the prior art, in which the bulges are generated in the dielectric layer, the present method provides for generating the bulges in an electrically conductive reflection layer. This has the advantage that the bulges can be arranged closer together and can be written with high spatial resolution. This is due to the fact that the electrically conductive reflective layer can have a very low layer thickness, so that the temperature change caused by the heating laser radiation is better limited locally due to the resulting lower thickness of the structure. Due to the smaller possible structure sizes, even complex shapes, such as microscopic sawtooth-shaped surface profiles, can be realised very precisely in accordance with the desired shape. Accordingly, with the diffractive optical element according to the invention, a high proportion of the light can be directed into the desired diffraction order, so that less unwanted diffraction noise is produced.

The laser mirror provided and the DOE produced by the method comprise the substrate, the optional absorption layer, the dielectric layer and the electrically conductive reflective layer, all of which are preferably parallel to each other, wherein the dielectric layer is adjacent to the substrate and, on the opposite side, to the electrically conductive reflective layer, or, if the absorption layer is present, the absorption layer is arranged between the substrate and the dielectric layer. In particular, it is provided that an underside of the dielectric layer or an underside of the absorption layer adjoins an upper side of the substrate. It is further preferred that, if an absorption layer is present, an upper side of the absorption layer borders on a lower side of the dielectric layer. In other words, the upper side of the electrically conductive reflection layer corresponds to the upper side of the DOE or the upper side of the laser mirror.

Where reference is made to an “electrically conductive reflective layer”, this refers to a mirror layer consisting of a metal or semi-metal and suitable for reflecting light, in particular laser light, of the first wavelength.

In particular, the DOE is a reflective DOE. This means that the beam shaping of the light beam with the first wavelength is achieved by reflection of the light beam at the diffractive optical element. In contrast to DOEs, in which the beam shaping is achieved by transmission of the laser beam through the DOE (transmissive DOEs), this is a DOE in which the light beam is reflected.

During the process, bulges are created in the electrically conductive reflective layer, which lead to microstructuring of the surface of the electrically conductive reflective layer. This means in particular that the surface of the electrically conductive reflective layer is not flat after the process, but has local areas that have a different height than before the process. Preferably, the majority of the bulges have a height of half the first wavelength perpendicular to the electrically conductive reflection layer. The height of the bulges refers to an extension of the bulge perpendicular to the electrically conductive reflection layer relative to an area around the local area. The bulges are preferably rotationally symmetrical, with the axis of rotation of the bulges perpendicular to the absorption layer. As a result, the bulges are circular when projected onto a plane parallel to the absorption layer. Furthermore, each of the bulges preferably has a sawtooth-shaped height profile.

The height of the bulges influences the use of the DOE for beam shaping of the light beam with the first wavelength, since efficient beam shaping with the DOE is only possible if the bulges typically have a height of at least half the first wavelength. The method allows the production of DOEs that are suitable for beam shaping of a light beam with a first wavelength of at least 10 nm, in particular EUV light. In other words, this means that the bulges typically have a height greater than 5 nm.

The method has the advantage that the treatment with the heating laser beam allows the bulges of the thin electrically conductive reflective surface to be produced with good spatial resolution and with precise control of the height and location of the bulges. Bulges of different heights can be created, with a height resolution of at least 0.5 nm, preferably at least 0.1 nm, which corresponds to the manufacturing accuracy of quasi-continuous DOEs with more than 2500 steps. In particular, the process can simultaneously achieve a high spatial resolution in the transverse direction of the structured reflective surface profile, which is 1 μm. The resolution determines the minimum achievable distance between the highest points of two adjacent bulges. At the same time, the resolution also determines the accuracy with which a specified surface profile of the DOE can be achieved. The method thus enables the production of continuous DOEs with small structure sizes and high diffraction efficiency. Accordingly, the electrically conductive reflection layer allows continuous DOEs to be realised by generating bulges, in particular for EUV light, with (initial) wavelengths down to 10 nm. In the state of the art, 100 nm optical wavelength represents a lower limit due to the absorption of shorter wavelength light in the dielectric reflection layers. The extension of the possible wavelength range is an essential feature of the invention.

According to a preferred further development of the invention, it is envisaged that the heating laser radiation comprises a series of focused heating laser beams or a heating laser beam diffracted at a spatial light modulator. A series of focused heating laser beams is understood to be a single focused heating laser beam that scans the electrically conductive reflection layer or the absorption layer. In this case, either the heating laser beam can be deflected in at least one spatial direction and/or the laser mirror can be moved. In order to increase the production speed of this writing process, heating laser radiation diffracted at a spatial light modulator can also be used instead of a single focused heating laser beam. This achieves parallelisation so that several bulges can be generated simultaneously or in quick succession. Depending on the light modulator, such as a galvo scanner, the heating laser beam can be diffracted in at least one spatial direction. The light modulator enables the heating laser beam to be quickly deflected or switched.

With regard to the exact shape of the surface profile of the DOE produced by the method, it is preferable to determine this by means of a topographical recording of the reflective metal layer using a Mirau interferometer. This produces a topographical map of the height profile of the reflective layer of the DOE. According to a preferred further development, this image is electronically compared with the desired, previously calculated height profile, after which renewed irradiation with a sequence of heating laser beams can take place in order to correct any remaining deviations and better adapt the height profile to the desired profile. It is particularly preferred that this iterative process is repeated several times in an automated manner in order to achieve a further increased manufacturing accuracy.

In connection with the height of the bulges, the method preferably provides that the height of the bulges can be influenced by a heat input of the heating laser beam per volume into the absorption layer and/or into the dielectric layer and/or into the electrically conductive reflection layer. It is preferably provided that, when treating the laser mirror with a series of focused heating laser beams, the second wavelength, a power of the heating laser beam, a focusing of the heating laser beam, a heating duration, the absorption layer of the laser mirror, the dielectric layer of the laser mirror and/or a layer thickness of the electrically conductive reflection layer are selected in such a way that the height of the bulges reaches, in particular, half of the first wavelength.

The heat input of the heating laser beam can be controlled by different parameters. Preferably, the wavelength of the heating laser beam, i.e. the second wavelength, and an absorption spectrum of the absorption layer and/or the dielectric layer and/or the electrically conductive reflection layer are matched to each other. This ensures that a portion of the heating laser beam is absorbed by the absorption layer and/or the dielectric layer and/or the electrically conductive reflection layer.

In particular, it is provided that the laser mirror provided is suitable for reflecting a light beam of the first wavelength. Preferably, the laser mirror provided in the first step of the method, which essentially represents the blank of the DOE, is a highly reflective laser mirror for reflecting the light beam with the first wavelength. In this context, highly reflective means that the laser mirror has a reflectance of more than 90% for the first wavelength, provided that this is in the visible or infrared spectral range, and of more than 50% provided that this is in the ultraviolet spectral range. It is further preferred that the laser mirror is suitable for reflecting light with a first wavelength greater than 10 nm. Due to the precise heights and transverse resolution of the DOE manufacturing process that can be achieved with the method, approximately 99% of the reflected light can be directed into the desired useful diffraction order. In particular, the proportion of light deflected into disruptive other diffraction orders can be reduced to less than 1%.

According to a preferred further development of the invention, the electrically conductive reflective layer consists at least partly of aluminium and/or silver and/or silicon and/or gold. Silver has the advantage that this material has a high reflectance over a wide wavelength range. This means that the electrically conductive reflective layer is designed in such a way that the light beam with the first wavelength is reflected at the electrically conductive reflective layer. When metals are used, the electrically conductive reflective layer enables reflection over a wide wavelength range. When silver and aluminium are used as materials for the electrically conductive reflective layer, the possible reflection range extends across the entire visible optical wavelength range (400-800 nm) and also into the ultraviolet range (up to 120 nm for aluminium). For light in the even shorter EUV wavelength range (down to 10 nm), the reflective layer can be realised with conductive metal-semimetal layer structures. A preferred embodiment, in particular for light at a wavelength of 13.5 nm, as used in EUV lithography, comprises the use of a molybdenum-silicon multilayer as the reflective layer. However, by using conductive materials, the reflective layer in the structure according to the invention can also be realised for long-wave light; for example, gold as a material achieves high reflection for this layer in a wavelength range above 700 nm and well into the infrared (up to 20 μm wavelength).

It is further preferred that the absorption layer consists of silicon or gold and/or the substrate consists of silicon, glass, CaF₂, MgF₂ or sapphire and/or the dielectric layer consists of SiO₂, Ta₂O₅, TiO₂, HfO₂, Al₂O₃, MgF₂, LaF₃, and/or ZrO₂. It is particularly preferred that the silicon in the absorption layer is amorphous silicon. It is further preferred that the substrate consists of quartz glass in order to enable the beam shaping of a laser beam even at high power. It is further preferred that the dielectric layer comprises a layer of a material which exhibits a permanently high expansion after heating by the heating laser beam. Preferably, ion beam sputtered Ta₂O₅, which emits argon gas when heated, is used, which leads to a permanent bulging of the electrically conductive reflection layer above it in the structure according to the invention. Since the reflection of the DOE is achieved by this electrically conductive layer, a sequence of several dielectric layers with different refractive in-dices is no longer necessary in the arrangement according to the invention. This allows the structure to be made very thin, which is extremely advantageous for the high resolution of this continuous DOE described above due to the thinness and close positioning of the heat source and the reflective layer. At the same time, with the arrangement according to the invention, the dielectric layer can be realised with a material that exhibits very high relative expansion after heat input, which, given a desired maximum height of the bulges, in particular half the first wavelength, allows the small total thickness of the layer structure that is desired for high spatial resolution.

According to a preferred further development, the thickness of the first dielectric layer is less than 700 nm, particularly preferably less than 400 nm. The thickness of the electrically conductive reflection layer is preferably less than 300 nm, particularly preferably less than 180 nm and particularly preferably less than 120 nm. The layer thickness of the electrically conductive reflection layer refers to the extent of the electrically conductive reflection layer perpendicular to its extension. When thin dielectric layers are used, a small overall thickness can thus be ensured, so that the temperature change caused by the heating laser beam is better limited locally.

The heat input of the heating laser beam can be controlled by various parameters. Preferably, the wavelength of the heating laser beam, i.e. the second wavelength, and an absorption spectrum of the absorption layer and/or the electrically conductive reflection layer are matched to each other. This ensures that a portion of the heating laser beam is absorbed by the absorption layer and/or the electrically conductive reflection layer.

In this context, it is preferably provided that, when treating the laser mirror with heating laser radiation, the second wavelength is between 200 and 700 nm and the absorption layer of the laser mirror is made of silicon, or that the second wavelength is between 200 and 2000 nm and the absorption layer of the laser mirror is made of gold, and/or the second wavelength is between 100 and 2000 nm. By means of these combinations of the wavelength of the heating laser beam and the absorption layer, bulges with a height of more than 50 nm can be produced very reliably. If the absorption layer is omitted, a UV laser with a second wavelength in the range of 200 to 400 nm is preferably used to treat the laser mirror with heating laser radiation.

According to a preferred further development of the invention, the distance between two adjacent bulges is less than 2 μm, preferably less than 1 μm. Due to the layer structure according to the invention, the additional electrically conductive reflection layer can have a low layer thickness. This low layer thickness allows the temperature change to be focused when the bulges are created using heating laser radiation. This means that the bulges can be arranged close to each other. While distances of approx. 8-10 μm are common in the prior art, the distances in the present invention can be limited to less than 1 μm. It is preferably provided that, when treating the laser mirror with heating laser radiation, the majority of the bulges arranged in a grid-like pattern are generated on an area of at least 0.25 cm². The grid-like arrangement of the bulges preferably refers to the plane parallel to the substrate, whereby the grid-like arrangement of the bulges may be oblique, right-angled, centred-rectangular, hexagonal or square. Deviations from the translational symmetry of the grid-like arrangement are also possible.

According to a preferred further development of the invention, the bulges have a sawtooth profile. Sawtooth refers to the shape of the teeth of a saw. The resolution of the heating determines the sawtooth shape. A non-ideal resolution leads to rounding of the sawtooth profile, whereby the radius of the rounding is determined by the resolution. The height resolution of at least 0.1 nm and the transverse resolution of 1 μm achievable with the method allow very high diffraction efficiency in the useful diffraction order even with different shapes of the height profile of the DOE, such as sawtooth profiles. This is particularly relevant because it means that diffraction into other diffraction orders, i.e. the stray light of the DOE, can be kept to a minimum.

According to a preferred further development of the invention, the laser mirror has a second dielectric layer. In this case, the electrically conductive reflective layer is arranged between the first dielectric layer and the second dielectric layer. In other words, the second dielectric layer is the top layer and serves in particular to protect the metal layer from oxidation by the surrounding atmospheric oxygen.

As already mentioned, the heat input of the heating laser beam per volume into the absorption layer and/or electrically conductive reflection layer can be influenced by the power of the heating laser beam. In this regard, it is preferably provided that, when treating the laser mirror with heating laser radiation, the power of the heating laser beam is at least 10 mW. The power is particularly preferred to be between 10 mW and 1000 mW.

According to a preferred further development of the invention, when a plurality of bulges are produced in the electrically conductive reflection layer by means of heating laser radiation, the temperature increase of the electrically conductive reflection layer is limited by cooling with a coolant, in particular with water.

In principle, it is possible that when treating the laser mirror with a series of focused heating laser beams, the heating laser beam is deflected in two dimensions during treatment and the laser mirror is not moved during this time. This reliably achieves the grid-like arrangement of bulges. However, according to a preferred further development of the method, it is intended that when treating the laser mirror with a series of focused heating laser beams, the laser mirror is moved during treatment along a displacement direction perpendicular to the heating laser beam and the heating laser beam is deflected during treatment perpendicular to the displacement direction, or that when treating the laser mirror with a diffracted heating laser beam, the heating laser beam is diffracted at a spatial light modulator in at least one spatial direction and directed onto the laser mirror. The heating laser beam can be diffracted in only one dimension and deflected in a second dimension or diffracted in two dimensions, so that a two-dimensional surface can be processed with a single diffracted heating laser beam. This makes it possible to produce a DOE in a particularly time-saving and precise manner, whose electrically conductive reflective layer has a surface area of at least 0.25 cm² a plurality of bulges arranged in a grid-like pattern. In particular, deviations from a grid-like translational symmetry are also possible. Furthermore, the displacement device can also be used to move the laser mirrors along both dimensions of the mirror plane.

The invention also provides a device for carrying out the method, wherein the device comprises a heating laser for generating a heating laser beam with the second wavelength, a focusing device for focusing the heating laser beam onto the laser mirror, a laser mirror positioning device and a control, wherein the control is designed to control the heating laser and the laser mirror positioning device.

According to a preferred further development of the invention, the device has a spatial light modulator for diffracting the heating laser beam or a deflection device for deflecting the heating laser beam, and the control is designed to control the heating laser, the light modulator or the deflection device, and the laser mirror positioning device. The control of the heating laser, the light modulator or the deflection device, and the laser mirror positioning device is carried out in particular independently of each other, so that the heating laser beam and the impact of the heating laser beam on the laser mirror can be optimally con-trolled.

According to a preferred further development of the invention, the laser mirror positioning device has a chamber designed to contain a coolant in such a way that contact is established between the coolant and the laser mirror. The cooling can be achieved in particular by sealing the reflective mirror surface (on the opposite side of the substrate) on the outside with a rubber ring during this process and filling the space between the mirror and the rubber ring with water after sealing. Limiting the temperature increase of the reflective metal mirror layer makes it possible to avoid temperature-induced changes in the structure of this film, thereby maintaining a spatially uniform high level of reflection.

The invention is explained in more detail below with reference to the drawings, using a preferred embodiment.

The drawings show

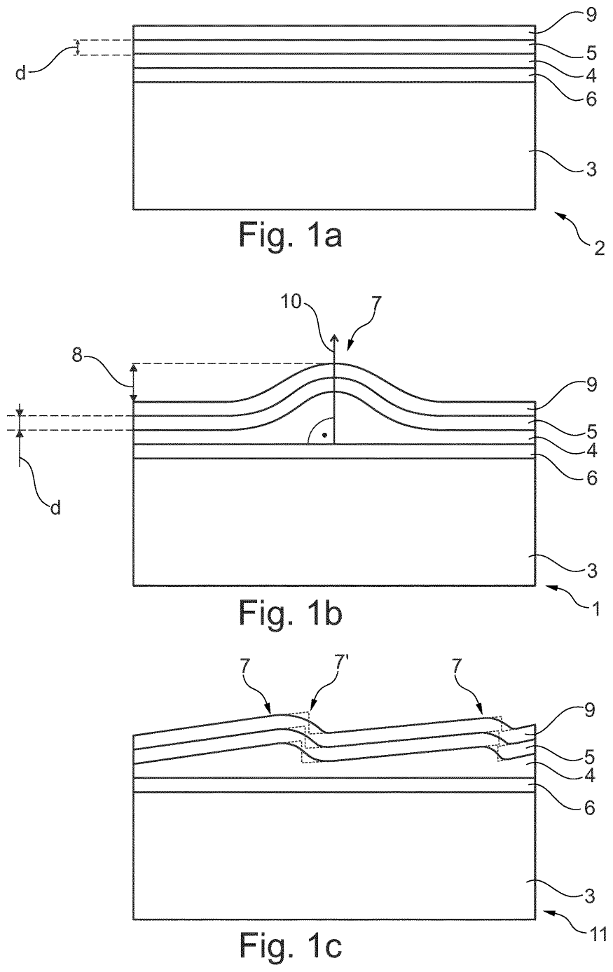

FIG. 1a a schematic cross-sectional view of the diffractive optical element with-out bulges,

FIG. 1b a schematic cross-sectional view of the diffractive optical element according to a preferred embodiment of the invention,

FIG. 1c a schematic cross-sectional view of the diffractive optical element according to a second preferred embodiment of the invention,

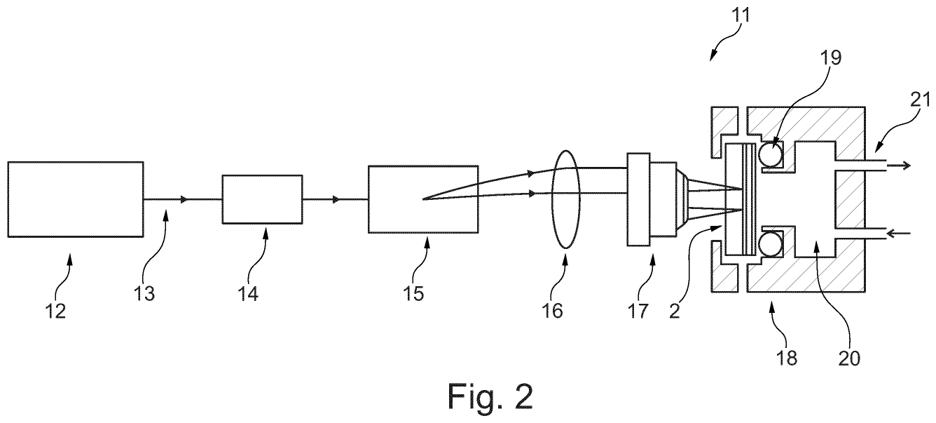

FIG. 2 a schematic representation of a device for carrying out the method according to a preferred embodiment of the invention.

FIGS. 1a, 1b and 1c show a schematic cross-sectional view of the DOE 1. The process comprises two steps, whereby in a first step, shown in FIG. 1a, a laser mirror 2 is provided as a blank for the DOE 1. The laser mirror 2 is suitable for reflecting a light beam with a first wavelength. In this embodiment, the laser mirror 2 has a layered structure consisting of a substrate 3, an absorption layer 6, a first dielectric layer 4, an electrically conductive reflection layer 5 and a second dielectric layer 9. All four layers 6, 4, 5, 9 are parallel to each other, with the absorption layer 6 being arranged between the substrate 3 and the first dielectric layer 4. The electrically conductive reflection layer 5 is arranged between the first dielectric layer 4 and the second dielectric layer 9.

In a second step, shown in FIGS. 1b and 1c, bulges 7 are formed in the electrically conductive reflection layer 5. In the preferred embodiment shown in FIG. 1b, these are rotationally symmetrical bulges which are produced at an interface between the electrically conductive reflection layer 5 and the first dielectric layer 4. An axis of rotation 10 of the rotationally symmetrical bulges 7 lies perpendicular to the first dielectric layer 4. When cutting through the bulge 7 along a plane perpendicular to the absorption layer 6, the bulge 7 is Gaussian with respect to this plane.

In FIG. 1 c, the bulges 7 have a sawtooth profile. The ideal edge of a perfect sawtooth 7′ is shown as a dashed line. The degree of rounding of the ideal shape 7′ is determined by the resolution of the heating. A non-ideal resolution of the sawtooth profile leads to rounding of the sawtooth profile, whereby the radius of the rounding is determined by the resolution. By locally limiting the heat development in the electrically conductive reflection layer 5, the resolution can be increased and the sawtooth shape can be achieved and improved. The height resolution of at least 0.1 nm and the transverse resolution of 1 μm achievable with this method allow a very high diffraction efficiency in the useful diffraction order for the sawtooth-shaped profile.

The bulges 7 of the electrically conductive reflection layer 5 are produced by treating the laser mirror 2 with a series of focused heating laser beams and/or with a diffracted heating laser beam 13, each with a second wavelength.

FIG. 2 shows a device 11 for carrying out the method with a diffracted heating laser beam 13. The heating laser beam 13 is emitted by a heating laser 12 and modulated in an acousto-optic modulator 14. The modulation comprises a power modulation of the heating laser pulses. The heating laser beam 13 is then modulated and diffracted in a light modulator 15. The diffraction can also take place in several directions. The diffracted heating laser beam 13 is aligned by means of a lens 16 so that a directional deflection of the light modulator 15 is converted into a positional deflection. By means of a focusing device 17, for example a microscope objective, the heating laser beam 13 is directed onto the laser mirror 2 or onto the substrate layer. The laser mirror 2 is mounted in a laser mirror positioning device 18. The laser mirror positioning device 18 comprises a chamber into which coolant 20 can be introduced via the inlet or outlet 21. The chamber is directly adjacent to the laser mirror 2 and is sealed with sealing rings 19. In this way, the laser mirror 2 can be cooled from the side facing away from the substrate.

### LIST OF REFERENCE SIGNS

1 diffractive optical element, DOE
2 Laser mirror
3 Substrate
4 First dielectric layer
5 Electrically conductive reflective layer
6 Absorption layer
7 Bulge
7′ Ideal shape of the bulge
8 Height of the bulge
9 Second dielectric layer
10 Rotation axis
11 Device
12 Heating laser
13 Laser beam
14 Acousto-optic modulator
15 Light modulator
16 Lens
17 Focusing device
18 Laser mirror positioning device
19 Sealing ring
20 Coolant
21 Inlet or outlet

1. A method for manufacturing a diffractive optical element for beam shaping of a light beam with a first wavelength of at least 10 nm, comprising the following method steps:
providing a laser mirror, wherein the laser mirror includes a layer-like structure comprising a substrate, a dielectric layer, and an electrically conductive reflection layer, wherein the dielectric layer is adjacent to the substrate, or wherein the laser mirror comprises a layered structure comprising a substrate, a dielectric layer, an electrically conductive reflection layer and an absorption layer, wherein the absorption layer is located between the substrate and the dielectric layer,
generating a plurality of bulges in the electrically conductive reflection layer by treating the laser mirror with heating laser radiation having-comprising a second wavelength.

2. The method according to claim 1, wherein the heating laser radiation comprises a series of focused heating laser beams or a heating laser beam diffracted at a spatial light modulator.

3. The method according to claim 1, wherein the electrically conductive reflection layer at least partially comprises aluminum and/or silver and/or silicon and/or gold.

4. The method according to claim 1, wherein the distance between two adjacent bulges is less than 2 μm.

5. The method according to claim 1, wherein the bulges comprise a sawtooth-shaped profile.

6. The method according to claim 1, wherein the electrically conductive reflective layer comprises a layer thickness of less than 300 nm.

7. The method according to claim 1, wherein the dielectric layer comprises a layer thickness of less than 700 nm.

8. The method according to claim 1, wherein the laser mirror comprises a second dielectric layer and the electrically conductive reflection layer is arranged between the first dielectric layer and the second dielectric layer.

9. The method according to claim 1, wherein, when treating the laser mirror with the heating laser radiation, the power of the heating laser beam is at least 10 mW.

10. The method according to claim 1, wherein, when a plurality of bulges are formed in the electrically conductive reflection layer by heating laser radiation, the temperature rise of the electrically conductive reflection layer is limited by cooling with a coolant.

11. The method according to claim 1, wherein, when treating the laser mirror with a series of focused heating laser beams, the laser mirror is displaced during the treatment along a displacement direction perpendicular to the heating laser beam and the heating laser beam is deflected during the treatment perpendicular to the displacement direction, or the laser mirror is displaced during the treatment along two displacement directions orthogonal to each other, both perpendicular to the heating laser beam, or wherein, when treating the laser mirror with a diffracted heating laser beam, the heating laser beam is diffracted at a spatial light modulator in at least one spatial direction and directed onto the laser mirror.

12. A device for carrying out the method according to claim 1, wherein the device comprises a heating laser for generating a heating laser beam with the second wavelength, a focusing device for focusing the heating laser beam onto the laser mirror, a laser mirror positioning device and a control, wherein the control is designed to control the heating laser and the laser mirror positioning device.

13. The device according to claim 12, wherein the device comprises a spatial light modulator for diffracting the heating laser beam or a deflection device for deflecting the heating laser beam, and the control device is designed to control the heating laser, the light modulator or the deflection device, and the laser mirror positioning device.

14. The device according to claim 12, wherein the laser mirror positioning device comprises a chamber and the chamber is designed to contain a coolant in such a way that contact is established between the coolant and the laser mirror.
